(19) United States
(12) Patent Application Publication
(10) Pub. No.: US 2009/0034387 A1
(43) Pub. Date: Feb. 5, 2009

(54) OPTICAL STORAGE MEDIUM AND PLAYER

(76) Inventor: Hiroshi Hamasaka, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 11/813,786

(22) PCT Filed: Jan. 25, 2006
(86) PCT No.: PCT/JP2006/301143

§ 371 Date: Jul. 12, 2007

(30) Foreign Application Priority Data
Jan. 28, 2005 (JP) 2005-020715

(51) Int. Cl. G11B 3/74

(52) U.S. Cl. 369/94

(57) ABSTRACT

An optical storage medium that allows the user to recognize a given disk as a hybrid one, no matter whether the disk is loaded into a single format player or a multi-format player, is provided. The optical storage medium includes a stack of first and second storage layers with mutually different storage densities. Management information indicating the presence of the second storage layer is stored on the first storage layer.

### TECHNICAL FIELD

The present invention relates to an optical storage medium including multiple types of storage layers with mutually different storage densities and also relates to a player for selecting one of those storage layers of such a storage medium and retrieving information from that storage layer.

### BACKGROUND ART

Various types of optical information storage media (which will also be referred to herein as “optical storage media”), including CDs and DVDs, have been developed.

Recently, an optical disk including multiple storage layers with mutually different storage densities (or recording formats), i.e., a so-called “hybrid disk”, has been put on the market. For example, Patent Document No. 1 discloses a hybrid disk including a storage layer that uses the same format as CDs (which is called a “CD layer”) and a storage layer that uses the same format as DVDs (which is called a “DVD layer”). On the other hand, Patent Document No. 2 discloses a hybrid disk including a storage layer that uses the same format as a high definition (HD) disk containing audio information (which is called an “HD layer”) and a CD layer.

As these hybrid disks have been developed, a player that can retrieve information from any of those storage layers of a hybrid disk (which is called a “multi-format player”) has also been developed. Those storage layers with mutually different storage densities have different physical shapes, and therefore, have an optical difference, too. The multi-format player can sense that difference, recognize the desired storage layer and perform an appropriate type of signal processing according to the information stored on that layer, thereby retrieving the information. Patent Document No. 2 discloses such a player.

One of the advantages of the hybrid disk is that the disk allows even a player compliant with only one format (which is called a “single format player”) to retrieve information from it. For example, even a CD player and a DVD player, both of which are single-format players, can retrieve information from the hybrid disk disclosed in Patent Document No. 1. That is to say, a CD player could read information from the CD layer and a DVD player could read information from the DVD layer.

However, the optical properties of each layer of the hybrid disk are not always the same as those of the only storage layer of an optical disk. That is why if a hybrid disk were loaded by mistake into a player that is not compatible with hybrid disks, the laser beam might be accidentally focused on one of its storage layers. In that case, the player might cause a failure.

To overcome such a problem, Patent Document No. 3 discloses a method for preventing a conventional player from malfunctioning in a situation where a dual-layer disk is loaded into the player. The dual-layer disk disclosed in Patent Document No. 3 includes a storage layer corresponding to that of a conventional CD (which is called a “low-density storage layer”) and another storage layer with higher density. In a predetermined area of the high-density storage layer, a piece of information indicating that this is not a CD (i.e., information that is not defined by CD's signal format) is stored at such a low storage density as to be easily read even by a CD player. By storing such a piece of information, even if the laser beam happened to be focused on the high-density storage layer, the playback operation of the player would stop halfway. Consequently, it is possible to prevent the CD player from malfunctioning.
Patent Document No. 1: Japanese Patent Application Laid-Open Publication No. 10-40754
Patent Document No. 2: Japanese Patent Application Laid-Open Publication No. 2000-156033
Patent Document No. 3: Japanese Patent Application Laid-Open Publication No. 2002-237034

### DISCLOSURE OF INVENTION

### Problems to be Solved by the Invention

When loaded with a hybrid disk, a single format player can recognize its compatible storage layer but never recognizes the other storage layer or notifies the user of the presence. That is why the user may not recognize the disk as a hybrid disk properly. In that case, even when he or she purchases a player that can retrieve information from that other storage layer, he or she will not imagine that unknown information is retrievable from that disk.

In such a situation, it would be very inconvenient for the user if the package or label of the disk were the only means for identifying the disk for him or her. It is also unrealistic for him or her to always get multiple types of single-format players ready to see whether the given disk is a hybrid one or not.

Meanwhile, when a multi-format player is used, it takes a lot of time to get a loaded disk ready to play, which is also a problem.

For example, when loaded with a disk, a player sees if every storage layer of the disk is accessible and determines whether the disk is a hybrid one or not. It also takes a rather long time to get this processing done, and therefore, the user has to wait a long time before the player gets ready to be play the disk.

On top of that, the conventional multi-format player does not allow the user to decide, according to the playing environment or his or her preference, from which storage layer information should be retrieved first. That is why the user may sometimes have to suspend playback for a while to make a selection, and he or she will have to wait a long time before he or she can retrieve his or her desired information.

This problem will be described in further detail by way of a specific example. Suppose high definition (HD) compressed data of a movie is stored on the high-density storage layer of a hybrid disk and standard definition (SD) compressed data of the same movie is stored on the standard density storage layer thereof. If the user is now using an HD compatible appliance such as an HD digital TV set, the player may play back the HD quality movie from the high-density storage layer. However, if he or she is using an SD compatible appliance such as a conventional NTSC analog TV set, then he or she has to stop the output of the HD quality movie once and then switch the outputs into an SD quality movie, which is very inconvenient for him or her. Also, according to the settings of the device installed, processing of converting HD quality into SD quality could start automatically, and the SD quality produced by the conversion might be inferior to that of the standard density storage layer of the hybrid disk.

Also, music, image, video or any other copyrighted work may be distributed, or its copy generation may be managed, on different conditions according to its quality. For example, in a situation where the same movie or music clip is stored as standard quality compressed data and high quality compressed data on the standard density storage layer and the high-density storage layer, respectively, the distribution and copy generation management are preferably controlled under respectively different conditions.

An object of the present invention is to provide an optical storage medium, a player and a playback method that allow the user to recognize a given disk as a hybrid one, no matter whether the disk is loaded into a single format player or a multi-format player. Another object of the present invention is to make a multi-format player select a storage layer to retrieve information from either automatically according to the playback environment or at the user's request, thereby starting to retrieve desired information as quickly as possible.

### Means for Solving the Problems

An optical storage medium according to the present invention includes a stack of first and second storage layers with mutually different storage densities. Management information indicating the presence of the second storage layer is stored on the first storage layer.

The first storage layer may have a lead-in area, and the management information may be stored in the lead-in area of the first storage layer.

User data indicating the presence of the first storage layer may be stored on the second storage layer.

The second storage layer may have a lead-in area, and the user data may not be stored in the lead-in area of the second storage layer but in a different area of thereof.

The second storage layer may further have a data area, and the user data may be stored in the data area of the second storage layer.

The user data may relate to at least one of video and audio indicating the presence of the first storage layer.

Sequence information defining a procedure of processing to be carried out first when data is read out from the second storage layer may be stored in the data area of the second storage layer. The sequence information may define the procedure of presenting video based on the video data.

Each of the first and second storage layers may have a data area. A first piece of title information about a content of a first quality and a first piece of copyright management information for protecting the copyright of the content of the first quality may be stored in the data area of the first storage layer. A second piece of title information about a content of a second quality and a second piece of copyright management information for protecting the copyright of the content of the second quality may be stored in the data area of the first storage layer.

The first and second pieces of copyright management information may define mutually different copyright protection conditions.

A player according to the present invention retrieves information from an optical storage medium. The optical storage medium includes a stack of first and second storage layers with mutually different storage densities, and management information indicating the presence of the second storage layer is stored on the first storage layer. The player includes: a reading section for reading the management information when the player is loaded with the optical storage medium; and a control section for outputting information indicating the presence of the second storage layer based on the management information.

The first storage layer may have a lead-in area in which the management information is stored and a data area in which user data about at least one of video and audio indicating the presence of the second storage layer is stored. The reading section may further read the user data. And the control section may output at least one of video and audio based on the user data, thereby making a notification of the presence of the second storage layer.

The second storage layer may have a data area in which user data about at least one of video and/or audio indicating the presence of the first storage layer is stored. The reading section may further read the user data from the second storage layer. And the control section may output at least one of video and audio based on the user data of the second storage layer, thereby making a notification of the presence of the first storage layer.

Another player according to the present invention retrieves information from an optical storage medium. The optical storage medium includes a stack of first and second storage layers with mutually different storage densities. Video information of a first definition is stored on the first storage layer, while video information of a second definition is stored on the second storage layer. The player includes: a memory that stores in advance output information specifying definition of video to output; a control section for selecting, in accordance with the output information, either the first storage layer or the second storage layer to read video information from when the player is loaded with the optical storage medium; and a reading section for reading the video information from the first or second storage layer selected.

The player may further include an interface section that receives information, specifying a signal format acceptable for an output device, as the output information from a user.

Alternatively, the player may further include an interface section that receives information, specifying a signal format acceptable for an output device, as the output information from the output device.

### EFFECTS OF THE INVENTION

An optical storage medium according to the present invention includes two storage layers with mutually different storage densities, and one of the two storage layers stores management information indicating the presence of the other storage layer. And if the player notifies the user of the presence of the other storage layer based on this management information, he or she can sense the presence of that layer easily.

In particular, according to the present invention, the management information is stored in the lead-in area of the first storage layer and user data indicating the presence of the first storage layer is also stored in the data area of the second storage layer. Any type of information may be stored in the data area. For that reason, even if the data structure of the second storage layer is defined by a standard, for example, the player can still interpret that information and present its contents to the user. Consequently, he or she can sense the presence of the additional layer, no matter whether the player can retrieve information from only the first storage layer or only the second storage layer.

### BRIEF DESCRIPTION OF DRAWINGS

FIG. 1 illustrates the multilayer structure of an optical disk 100 according to a preferred embodiment of the present invention.

FIG. 2(a) shows the data structure of a high-density storage layer 102, while FIG. 2(b) shows the data structure of a low-density storage layer 104.

FIG. 3 shows correlation between the lead-in 201 of the high-density storage layer 102 and hybrid information 21.

FIG. 4 shows the configuration of a player 300 according to a preferred embodiment of the present invention.

FIG. 5 is a flowchart showing the procedure of initializing processing to be carried out by the player 300.

FIG. 6 shows an exemplary initializing screen.

FIG. 7 is a flowchart showing the procedure of playback processing to be carried out by the player 300.

FIG. 8 is a flowchart showing the procedure of information retrieval processing on the low-density storage layer 104.

FIG. 9 shows an exemplary on-screen message indicating the presence of the high-density storage layer 102.

FIGS. 10(a) and 10(b) show other exemplary data structures of the high-density storage layer 102 and low-density storage layer 104.

FIGS. 11(a) and 11(b) show exemplary on-screen messages that indicate the presence of the low-density storage layer directly and indirectly, respectively.

### DESCRIPTION OF REFERENCE NUMERALS

21 hybrid information
100 optical disk
101 protective glass layer
102 high-density storage layer
103, 105 base member
104 low-density storage layer
201, 211 lead-in
300 player
301 CPU
302 general-purpose memory
310 optical pickup
311 layer recognizing section
312 layer specifying section
313 signal switching section
316 user input interface (I/F)
317 video output format memory
318 connection interface (I/F)
319 copyright information processing section
320 TV set
321 TV
322 loudspeaker
330 HDMI cable
2025 SD presence information
2125 HD presence information
2024, 2124 copyright management information
3140 HD decoder
3150 SD decoder

### BEST MODE FOR CARRYING OUT THE INVENTION

Hereinafter, preferred embodiments of the present invention will be described with reference to the accompanying drawings.

In the following description of preferred embodiments, the information storage medium is supposed to be an optical storage medium (which will be referred to herein as an “optical disk”). The optical disk is supposed to be a read-only one in the following description.

Also, the optical disk is supposed to be a hybrid disk including a stack of two storage layers with mutually different storage densities. The information stored in each of these two storage layers is read optically with a light beam that has been emitted from a semiconductor laser diode. It should be noted that no single storage layer is supposed to have a plurality of storage areas with different storage densities.

Various types of storage layers may be combined with each other. In the following example, a storage layer, of which the format is compatible with DVDs and which will be referred to herein as a “low-density storage layer”, and another storage layer, of which the format is compatible with BDs and which will be referred to herein as a “high-density storage layer”, are used in combination. The low-density storage layer has a storage capacity of less than 5 GB (e.g., 4.7 GB) and the high-density storage layer has a storage capacity of 20 GB or more (e.g., 25 GB).

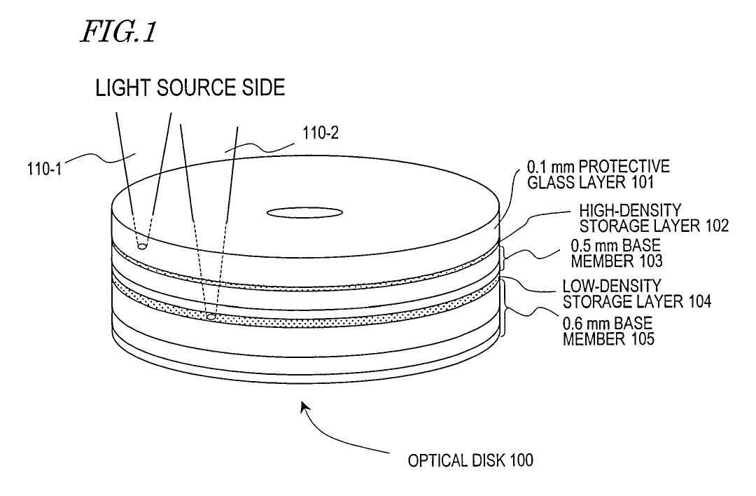

Hereinafter, the physical structure and the data structure of an optical disk according to a preferred embodiment of the present invention will be described specifically with reference to FIGS. 1 to 3.

FIG. 1 illustrates the multilayer structure of an optical disk 100 according to a preferred embodiment of the present invention. The optical disk 100 includes a protective glass layer 101, a high-density storage layer 102, a base member 103, a low-density storage layer 104, and another base member 105, which are stacked in this order. Among these members, information is stored on the high-density storage layer 102 and the low-density storage layer 104.

In reading information from the optical disk 100, the disk 100 is irradiated with a light beam that has come from under (or over), and been transmitted through, the protective glass layer 101. FIG. 1 shows a light beam 110-1 focused on the high-density storage layer 102 and another light beam 110-2 focused on the low-density storage layer 104 just for reference.

Hereinafter, the low-density storage layer 104 will be described first, and then the high-density storage layer 102 will be described.

The low-density storage layer 104 is located at a depth of 0.6 mm as measured from the disk surface on the light beam incoming side. The low-density storage layer 104 is arranged at that depth so as to be compatible with normal DVDs.

A DVD is formed by bonding together a transparent substrate including an information storage layer and having a thickness of 0.6 mm and a base member with a thickness of 0.6 mm. And a series of concave and convex pits are arranged thereon spirally at an interval of approximately 0.7 μm. The light beam is transmitted through the substrate with a thickness of 0.6 mm to irradiate the information storage layer. Consequently, information is read as a variation in the intensity of the reflected light.

That is why the low-density storage layer 104 is also arranged at the same depth as the DVD's storage layer and also retains information that is stored spirally at an interval of approximately 0.7 μm. The information stored on the low-density storage layer 104 is read with a red light beam 110-2 with a wavelength of about 660 nm.

On the other hand, the high-density storage layer 102 is located at a depth of approximately 0.1 mm as measured from the disk surface on the light beam incoming side so as to be compatible with BDs. This depth of 0.1 mm is equal to the thickness of the protective glass layer 101. The base member 103 with a thickness of 0.5 mm is sandwiched between the high-density storage layer 102 and the low-density storage layer 104. As a result, the light beam focused on the low-density storage layer 104 is less likely to be affected by the high-density storage layer 102, which is located away from the focal point.

The high-density storage layer 102 achieves storage density that is approximately five times as high as that of the low-density storage layer 104 and DVDs. For that purpose, information is also stored as spiral concave and convex pits at an interval of approximately 0.3 μm. The pit length of the high-density storage layer 102 is shorter than that of the low-density storage layer 104. The information stored on the high-density storage layer 102 is read with the light beam 110-1, which is transmitted through the protective glass layer 101 with a thickness of 0.1 mm and irradiates the high-density storage layer 102. As a result, the information is read as a variation in the intensity of the reflected light.

It should be noted that the protective glass layer 101 is actually often made of a resin and does not have to be made of glass, strictly speaking. Also, to read information from the low-density storage layer 104, the high-density storage layer 102 needs to be semi-transparent and transmits light at a predetermined ratio. The protective glass layer 101 and the base member 103 are transparent. The base member 105 has a thickness of 0.6 mm.

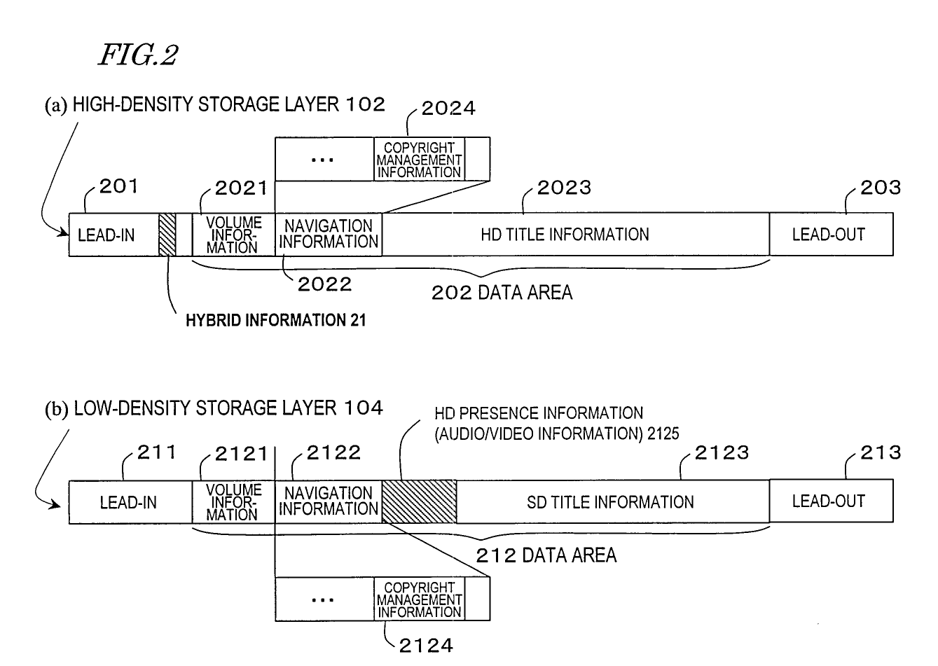

Next, the data structures of the high-density storage layer 102 and low-density storage layer 104 will be described with reference to FIG. 2.

FIG. 2(a) shows the data structure of the high-density storage layer 102, while FIG. 2(b) shows that of the low-density storage layer 104. Different data structures compliant with the BD and DVD standards, respectively, are defined for these layers. In each of FIGS. 2(a) and 2(b), the direction in which these areas are arranged from left to right on the paper corresponds to the direction in which they are actually arranged from the inner edge toward the outer edge on the optical disk 100.

Referring to FIG. 2(a), arranged on the high-density storage layer 102 are a lead-in area 201, a data area 202, and a lead-out area 203.

The lead-in area (which will be simply referred to herein as a “lead-in”) 201 is arranged as the innermost area such that an information retrieval device can access that area most quickly when loaded with an information storage medium. The lead-in is provided to not only make the player perform stabilized tracking but also store physical control information.

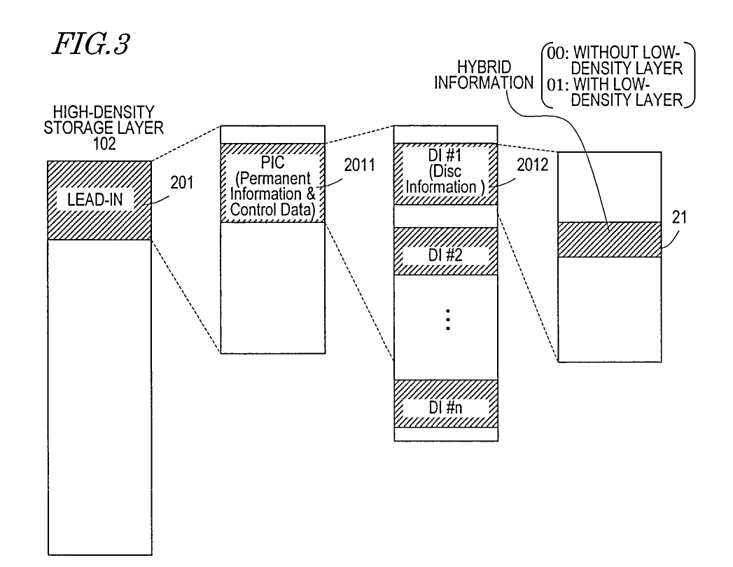

In the lead-in 201 of the high-density storage layer 102, stored is a piece of management information (which will be referred to herein as “hybrid information”) 21 indicating that the optical disk 100 has another storage layer that has a different storage density from the high-density storage layer 102. In this preferred embodiment, a value indicating the presence of the low-density storage layer 104 is given as the hybrid information 21, which will be described in further detail later with reference to FIG. 3.

In the data area 202, stored are volume information 2021, navigation information 2022 and high definition (HD) title information 2023. The volume information 2021 shows a file structure. The navigation information 2022 is control information such as the order of presentation of a content. The HD title information 2023 is compressed digital data about high-definition video (HD video). Specifically, the navigation information 2022 includes content's copyright management information 2024 about the HD title information 2023. The copyright management information 2024 includes copy control information and may be used to make the HD title information 2023 “copying prohibited”, “copying permitted one generation only”, “copying permitted without restrictions” or “distribution prohibited”, for example.

The lead-out area (which will be simply referred to herein as a “lead-out”) 203 is provided mainly to make the player perform stabilized tracking.

Next, referring to FIG. 2(b), the data structure of the low-density storage layer 104 also includes a lead-in 211, a data area 212 and a lead-out 213. The lead-in 211 and the lead-out 213 are provided for the same purposes as the counterparts of the high-density storage layer 102.

However, the lead-in 211 of the low-density storage layer 104 includes no information corresponding to the hybrid information 21 so as to be compliant with the DVD standard. That is to say, the DVD standard does not require providing information corresponding to the hybrid information 21 for the lead-in. That is why if such a type of information were included, then the information stored on the low-density storage layer 104 would no longer be retrievable for a conventional (DVD) player. Thus, to guarantee playback using a conventional DVD player, no information corresponding to the hybrid information 21 is stored in the lead-in 211.

Meanwhile, in the data area 212, stored is a piece of information indicating the presence of another storage layer with a different storage density (i.e., the high-density storage layer 102). Hereinafter, the data area 212 will be described in further detail.

In the data area 212, stored are volume information 2121, navigation information 2122, and standard definition (SD) title information 2123.

The volume information 2121 shows a file structure. The navigation information 2122 is control information such as the order of presentation of a content. The SD title information 2123 is compressed digital data about standard-definition video. Specifically, the navigation information 2122 includes copyright management information 2124 about the SD title information 2123. It should be noted that the copyright management information 2124 is provided for a content with the SD title information 2123, unlike the copyright management information 2024 for a content with the HD title information 203.

In this preferred embodiment, the HD title information 2023 and the SD title information 2123 are about the same content with different qualities. That is why by providing respective pieces of copyright management information for these pieces of title information for two different qualities, the distribution condition and copy generation management are controllable as if they were two different contents. For that reason, the copyright management information 2024 for the HD title information 2023 and the copyright management information 2124 for the SD title information 2123 do not have to include the same contents but may have totally different contents.

In the data area 212, further stored is HD presence information 2125, which indicates the presence of the high-density storage layer 102, or speaking more directly, that HD audio/video information is stored on this optical disk 100. This HD presence information 2125 is video information or audio information compliant with an MPEG standard, which can be read by a normal DVD player, for example. That is to say, this HD presence information 2125 is treated as normal video information or audio information that has been written on a data area where any type of information can be stored. The video information or audio information that is stored as the HD presence information 2125 is presented while a program sequence called “First Play PGC” is being executed.

The following Table 1 shows the data specifications of an HD title, while the following Table 2 shows those of an SD title. The amount of information that can be stored on the high-density storage layer 102 is approximately five times as large as that of the low-density storage layer 104. That is why video (e.g., a moving picture among other things) with a greater number of pixels can be stored on the high-density storage layer 102.

TABLE 1
High definition (HD) title

| | | |
|---|---|---|
| Video | Encoding method | MPEG2, MPEG4 |
| | Numbers of pixels | 1,920 × 1,080 |
| Audio | Encoding method | AAC |

| | |
|---|---|
| Maximum bit rate | 34 Mbps |

TABLE 2
Standard definition (SD) title

| | | |
|---|---|---|
| Video | Encoding method | MPEG2 |
| | Numbers of pixels | 720 × 480 |
| Audio | Encoding method | AC-3 |

| | |
|---|---|
| Maximum bit rate | 10 Mbps |

The HD title information 2023 may be stored in the format of an MPEG transport stream, for example. An MPEG transport stream includes at least video stream packets and audio stream packets that are multiplexed together.

As shown in Table 1, the video stream of the HD title is encoded compliant with either the MPEG-2 standard or the MPEG-4 standard. The maximum numbers of pixels of the video are 1,920 horizontally and 1,080 vertically. Likewise, the audio stream of the HD title is encoded compliant with the AAC standard with high affinity for a digital broadcast.

On the other hand, the SD title information 2123 may be stored in the format of an MPEG program stream, for example. An MPEG program stream includes video stream packets (or packs) and audio stream packets (or packs) that are multiplexed together.

As shown in Table 2, the video stream of the SD title is encoded compliant with the MPEG-2 standard. The maximum numbers of pixels of the video are 720 horizontally and 480 vertically. Likewise, the audio stream of the SD title is encoded compliant with the AC-3 standard.

In this preferred embodiment, the HD title and the SD title are about the same content with different audio/video qualities. The video quality is proportional to the magnitude of the bit rate. For example, HD video has a maximum bit rate of 34 Mbps and SD video has a maximum bit rate of 10 Mbps. Since video has higher resolution than audio, video includes a greater amount of information than audio.

The high-density storage layer 102 has a sufficient data storage capacity. That is why an additional content, which is not present on the low-density storage layer 104 (i.e., a so-called “bonus content”), is sometimes stored on the high-density storage layer 102.

Next, the hybrid information 21 will be described in detail with reference to FIG. 3, which shows correlation between the lead-in 201 of the high-density storage layer 102 and the hybrid information 21.

The lead-in 201 is subdivided into various areas, one of which is called permanent information and control data (PIC) area 2011. The PIC area 2011 includes more than one disk information (DI) area #1, . . . and #n. And the hybrid information 21 is stored at a predetermined data location within the DI area #1 2012.

The hybrid information 21 may have any specific data structure as long as the information can indicate whether the low-density storage layer 104 is present or not. For example, hybrid information 21 “00” may indicate that there is no low-density storage layer 104, i.e., the optical disk is not a hybrid disk, while hybrid information 21 “01” may indicate the presence of the low-density storage layer 104. Alternatively, the two-bit value may be replaced with a simple one-bit value, too.

The hybrid information 21 may have the value “00” indicating that the disk is not a hybrid disk because a non-hybrid disk such as a BD-ROM could store the hybrid information 21, too. The high-density storage layer 102 of a hybrid disk and the storage layer of a BD-ROM may have the same data structure. That is why the player can recognize the type of the given disk by the value of the hybrid information.

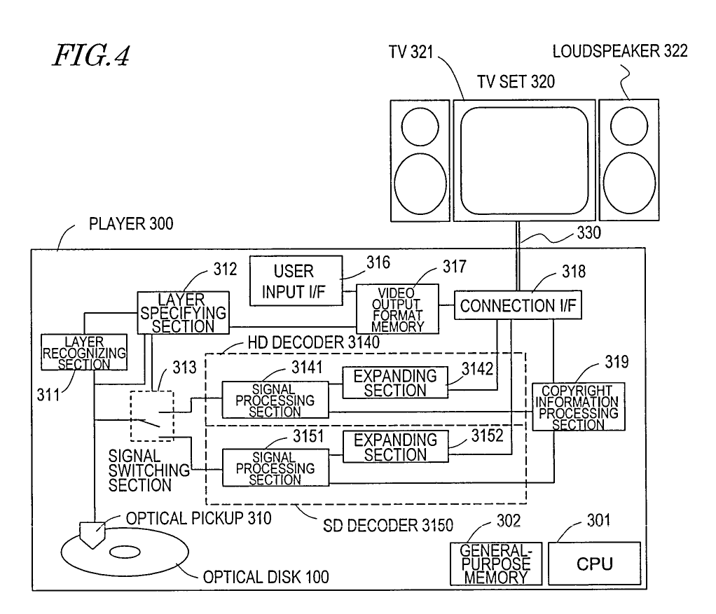

Hereinafter, the configuration and operation of an apparatus that can retrieve information from the optical disk 100 described above will be described with reference to FIG. 4.

FIG. 4 shows the configuration of a player 300 according to this preferred embodiment. A TV set 320 connected to the player 300 is also shown in FIG. 4. The player 300 and the TV set 320 are connected together via an HDMI cable 330.

The player 300 can retrieve information from respective layers of the optical disk 100 including the high-density storage layer 102 and the low-density storage layer 104. When loaded with the optical disk 100 inserted, the player 300 reads various sorts of information from the optical disk 100 and then outputs video information and audio information at such qualities that the TV 321 and loudspeakers 322 of the TV set 320 can deal with.

It should be noted that the player 300 could also retrieve information from a normal DVD with the same storage density as the low-density storage layer 104 and from a BD with the same storage density as the high-density storage layer 102.

The player 300 includes a central processing unit (CPU) 301, a general-purpose memory 302, an optical pickup 310, a layer recognizing section 311, a layer specifying section 312, a signal switching section 313, a user input interface (I/F) 316, a video output format memory 317, a connection interface (I/F) 318, a copyright information processing section 319, an HD decoder 3140 and an SD decoder 3150.

Among these components, the optical pickup 310, the user input I/F 316, the video output format memory 317 (which will be simply referred to herein as a “format memory 317) and the connection I/F 318 are provided as independent pieces of hardware. The HD decoder 3140 and the SD decoder 3150 may be provided as either independent decoder circuits (or chips) or a single decoder chip also including the signal switching section 313. Alternatively, the HD decoder 3140 and the SD decoder 3150 may share part of their processors.

On the other hand, the layer recognizing section 311, the layer specifying section 312, the signal switching section 313 and the copyright information processing section 319 may be provided as respectively independent dedicated circuits. Or the CPU 301 may perform the functions of these components (which will be described in detail later) by executing a computer program, for example. For the sake of simplicity, those components are shown in FIG. 4 separately from the CPU 301.

Hereinafter, the functions of the respective components will be described one by one.

The CPU 301 controls the overall operation of the player 300.

The general-purpose memory 302 is a known random access memory (RAM) and stores a computer program, temporary data and so on when the CPU 301 is operating.

The optical pickup 310 emits a light beam toward the optical disk 100 and focuses it on either the high-density storage layer 102 or the low-density storage layer 104. Also, the optical pickup 310 performs tracking so as to follow the tracks on the high-density storage layer 102 or the low-density storage layer 104, and reads information from the high-density storage layer 102 or the low-density storage layer 104, thereby outputting a read signal.

The layer recognizing section 311 determines, based on the read signal supplied from the optical pickup 310, whether the layer on which the light beam is currently focused and which is being tracked by the optical pickup 310 now is the low-density storage layer 104 or the high-density storage layer 102.

In accordance with the decision made by the layer recognizing section 311 and the contents of the format memory 317, the layer specifying section 312 determines the storage layer to retrieve information from and instructs the optical pickup 310 which storage layer the light beam should be focused on. The layer specifying section 312 also instructs the signal switching section 313 to switch the read signals.

The signal switching section 313 switches the transmission paths of the read signal supplied from the optical pickup 310, thereby selecting either the HD decoder 3140 or the SD decoder 3150 to process the signal. If the player 300 is loaded with the optical disk 100, the signal switching section 313 may switch the transmission paths not just when information should start to be read but also at an arbitrary time as well. Specifically, if the player 300 is loaded with a BD, the signal switching section 313 switches the paths into a playback path leading to the HD decoder 3140 when information starts to be read. On the other hand, if the player 300 is loaded with a DVD, the signal switching section 313 switches the paths into a playback path leading to the SD decoder 3150.

In FIG. 4, the signal switching section 313 is shown as a hardware switch. However, this is just an example to make the function of the switching section 313 easily understandable. Alternatively, switching may also be done by means of software. For example, when the CPU 301 of the player 300 or a decoder chip, in which the HD decoder 3140 and the SD decoder 3150 are integrated together, executes a software program, the switching section 313 may be realized as a part of branch decision processing, which is carried out to determine whether decoder to function is the HD decoder 3140 or the SD decoder 3150.

The HD decoder 3140 includes a signal processing section 3141 and an expanding section 3142. The signal processing section 3141 modulates, demodulates and corrects the errors of the signal that has been read from the high-density storage layer 102. The processed signal includes encoded video information, encoded audio information and copyright management information. The signal processing section 3141 separates the encoded video information and encoded audio information from the copyright management information and sends the encoded information to the expanding section 3142 and the copyright management information to the copyright information processing section 319, respectively. The expanding section 3142 decodes the encoded video information and audio information, thereby generating audio information and video information.

The SD decoder 3150 includes a signal processing section 3151 and an expanding section 3152. The signal processing section 3151 modulates, demodulates and corrects the errors of the signal that has been read from the low-density storage layer 104. The processed signal includes encoded video information, encoded audio information and copyright management information. The signal processing section 3151 separates the encoded video information and encoded audio information from the copyright management information and sends the encoded information to the expanding section 3152 and the copyright management information to the copyright information processing section 319, respectively. The expanding section 3152 decodes the encoded video information and audio information, thereby generating audio information and video information.

Since a video or audio content stored at its associated definition in each of the high-density storage layer 102 and the low-density storage layer 104 is provided with its own copyright management information, the best possible method of copyright management can be provided.

The user input I/F 316 is in charge of exchange of information between the user and the player 300, while the connection I/F 318 is in charge of exchange of information between the TV set 320 and the player 300.

The user input I/F 316 is used when the user is inputting performance information that specifies the display performance of the TV set 320 using a remote controller, for example. As used herein, the “performance information” means information that specifies a signal format acceptable for the TV set 320. In this preferred embodiment, the performance information is supposed to be a piece of information that specifies a video signal format. Specifically, the performance information may be a piece of information indicating whether the TV set 320 has the ability to display both HD video and SD video or the ability to display only SD video, for example.

Meanwhile, the connection I/F 318 is compliant with the HDMI standard and can keep up bidirectional communications with the TV set 320. Specifically, the connection I/F 318 requests the performance information from the TV set 320, which sends its own performance information to the connection I/F 318 in response to the request. These processing steps are carried out automatically compliant with the standard and the user does not have to do anything about that.

The format memory 317 stores information that defines the format of the signal to be output from the player 300 (which will be referred to herein as “output defining information”). The format memory 317 may be a rewritable EEPROM. Once set, the format memory 317 retains the output defining information even if the player 300 is turned OFF after that.

The output defining information is generated by the CPU 301 based on the performance information of the TV set 320 that has been acquired by way of the user input I/F 316 and the connection I/F 318. In this preferred embodiment, if the performance information indicates that the TV set has the ability to display both HD video and SD video, a value indicating BD is stored. On the other hand, if the performance information indicates that the TV set has the ability to display only the SD video, then a value indicating SD is stored. It should be noted that when the player 300 is shipped, a value indicating “automatic detection” is stored as the output defining information.

The copyright information processing section 319 sends the copyright management information to the connection I/F 318, thereby getting copyright protection processing (such as addition of copy generation management information and encryption) done on the audio and video information transmitted to the TV set 320.

The connection I/F 318 receives the output of the copyright information processing section 319 and the output of the expanding section 3142 or 3152, multiplexes these outputs together, and then send the multiplexed stream to the TV set 320. Optionally, an additional component for receiving these outputs, multiplexing them together and sending the multiplexed data stream to the connection I/F 318 may be provided. In that case, the connection I/F 318 will receive the multiplexed data stream and send it to the TV set 320.

Hereinafter, it will be described with reference to FIGS. 5 through 9 how the player 300 operates.

FIG. 5 shows the procedure of initializing processing to be carried out by the player 300. This processing is performed to determine from which layer information should be read earlier, the high-density storage layer 102 or the low-density storage layer 104, when the player 300 is loaded with the optical disk 100. That is why this processing is carried out when the user turns the player 300 ON for the first time or when the player 300 is loaded with a hybrid disk for the first time. However, the user can get this processing done at his or her desired time by manipulating a remote controller (not shown), for example.

First, in Step S51, the CPU 301 gets an initializing screen displayed on the TV 321. The data of the initializing screen may be stored in the general-purpose memory 302, for example, and may be output by way of the connection I/F 318 to the TV set 320 in accordance with the instruction given by the CPU 301.

Next, in Step S52, the CPU 301 reads the output defining information from the format memory 317 and shows the result on the initializing screen.

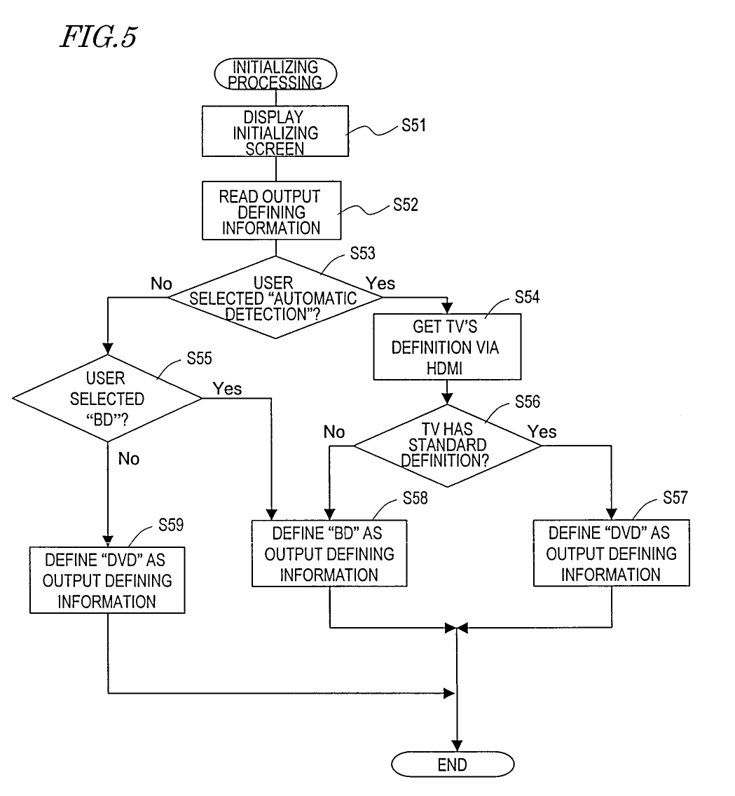

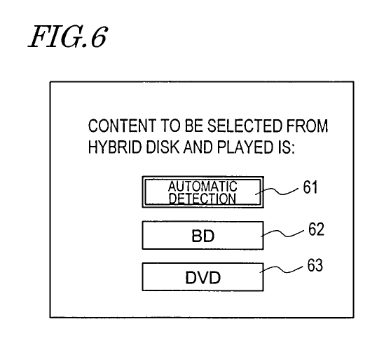

FIG. 6 shows an exemplary initializing screen. On the screen, three options 61, 62 and 63 are shown. As described above, when the player 300 is shipped, a value indicating “automatic detection” is stored in the format memory 317. For that reason, the option 61 is now highlighted.

Referring back to FIG. 5, it can be seen that the processing path branches in Step S53 according to the option 61, 62 or 63 that has been picked by the user.

Specifically, in Step S53, the CPU 301 determines whether the option picked by the user is “automatic detection” or not. If the answer is YES, the process advances to Step S54. Otherwise, the process advances to Step S55.

The processing steps that begin with Step S54 are carried out by the CPU 301 to automatically determine from which of the two storage layers 102 and 104 of the optical disk 100 information should be read earlier. In Step S54, the CPU 301 instructs the connection I/F 318 to get the performance information of the TV set 320 (more specifically, the definition of the TV 321) following the procedure defined by the HDMI standard.

Next, in Step S56, it is determined based on the performance information whether or not the TV 321 has the ability to display only SD video (i.e., whether the TV has standard definition or not). If the answer is YES, the process advances to Step S57. Otherwise (i.e., if the TV has high definition), then the process advances to Step S58.

In Step S57, the CPU 301 stores a value indicating DVD as the output defining information in the format memory 317. On the other hand, in Step S58, the CPU 301 stores a value indicating BD as the output defining information in the format memory 317.

Meanwhile, in Step S55, the CPU 301 determines whether the option picked by the user is BD or not. If the answer is YES, the process advances to Step S58. Otherwise (i.e., if the option picked by the user is DVD), then the process advances to Step S59. The processing step S59 is the same as the processing step S57, and the description thereof will be omitted herein.

When the output defining information is stored in the format memory 317 as a result of the processing described above, the CPU 301 reads the video or audio information from the selected storage layer of the optical disk 100 in accordance with that information. Once the output defining information has been set, the playback processing may be carried out in accordance with that information until the processing shown in FIG. 5 is performed again.

Alternatively, another option “always detect automatically” may be provided and the CPU 301 may perform the processing steps S54, S56, S57 and S58 every time the optical disk 100 is inserted. Then, even if the user that has viewed programs on the TV 321 of the standard definition has newly purchased a high definition TV, he or she can enjoy HD video and audio without changing the settings of the player 300.

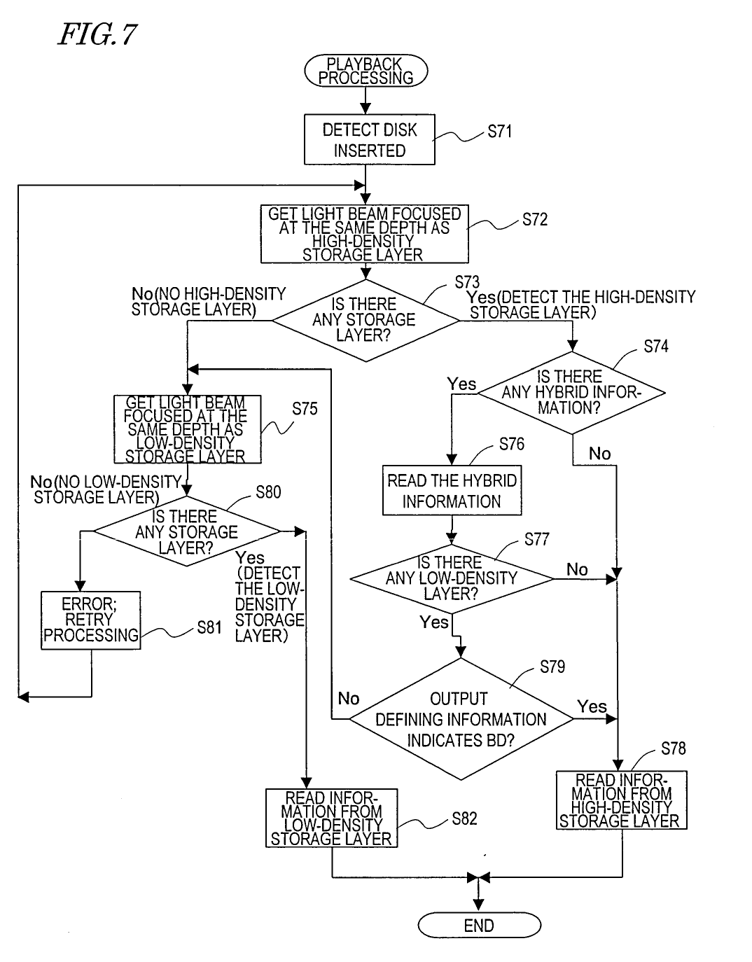

Hereinafter, it will be described with reference to FIG. 7 how the player 300 performs the playback processing.

FIG. 7 shows the procedure of playback processing to be carried out by the player 300.

First, in Step S71, the CPU 301 detects the insertion of a disk based on a signal supplied from a sensor (not shown), for example. As described above, the player 300 can retrieve information from not only a hybrid disk (such as the optical disk 100) but also DVDs and BDs as well. That is why it should be determined, through the processing steps that follow Step S71, which type of disk has been inserted.

Next, in Step S72, the CPU 301 activates the optical pickup 310 to get a light beam emitted, and then gets the light beam focused at the same depth as that of the high-density storage layer 102, i.e., at a depth of 0.1 mm as measured from the disk surface on the light beam incoming side. In this case, the light beam has a wavelength of about 405 nm.

Next, in Step S73, the layer recognizing section 311 measures the reflectance of the light beam, for example, thereby determining whether or not there is any storage layer at that depth. If the answer is YES, the process advances to Step S74. In that case, the optical disk inserted is either the optical disk 100 or a BD. If there is no storage layer, however, the process advances to Step S75.

In Step S74, the CPU 301 moves the optical pickup 310 to around the innermost area of the optical disk to determine whether or not the hybrid information 21 is stored at a predetermined location in the lead-in. If the answer is YES, the process advances to Step S76. Otherwise, the process advances to Step S78. If there is the hybrid information 21, then the given optical disk is recognized as the optical disk 100. If not, the given optical disk is recognized as a BD.

In Step S76, the CPU 301 makes the optical pickup 310 read the hybrid information 21. Then, in Step S77, the CPU 301 analyzes the hybrid information 21 to determine whether or not there is a low-density storage layer.

If the answer is YES, the process advances to Step S79. In that case, a message like “this optical disk is a hybrid disk” is either shown on the screen or output through the loudspeakers, thereby notifying the user of the fact. As a result, he or she can know that the given optical disk is a hybrid one, i.e., there are a high-density storage layer and a low-density storage layer in it. On the other hand, if there is no low-density storage layer, the process advances to Step S78. In that case, a message like “this optical disk is a BD” may be either shown on the screen or output through the loudspeakers to notify the user of the fact.

The information of the messages to be presented may be stored in the general-purpose memory 302, for example. The CPU 301 reads that information out and sends it out to either the TV 321 or the loudspeakers 322 via the connection I/F 318.

In Step S78, the optical pickup 310 reads information from either the high-density storage layer 102 or BD's storage layer of the optical disk 100, on which the light beam has already been focused, and displays that information. That is to say, the optical pickup 310 gets audio/video information decoded by the HD decoder 3140 and output to the TV 321 and the loudspeakers 322. After that, the process ends.

In Step S79, it is determined whether or not the output defining information has a value indicating “BD”. If the answer is YES, the process advances to Step S78. Otherwise (i.e., if the information has a value indicating “DVD”), the process advances to Step S75.

In Step S75, the CPU 301 activates the optical pickup 310 to get a light beam emitted, and then gets the light beam focused at the same depth as that of the low-density storage layer 104, i.e., at a depth of 0.6 mm as measured from the disk surface on the light beam incoming side. In this case, the wavelengths of the light beam are changed into about 650 nm.

Next, in Step S80, the layer recognizing section 311 measures the reflectance of the light beam, for example, thereby determining whether or not there is any storage layer at that depth. If the answer is NO, the process advances to Step S81. On the other hand, if the answer is YES, the process advances to Step S82. In that case, the optical disk inserted is either the optical disk 100 or a DVD.

In Step S81, retry processing is carried out because it is determined that the type of the given disk must have been recognized by mistake, and then the process goes back to Step S72. If no storage layer can be detected from the disk inserted even by performing the retry processing a predetermined number of times, the process may end.

In Step S82, the optical pickup 310 reads information from either the low-density storage layer 104 or DVD's storage layer of the optical disk 100, on which the light beam has already been focused, and displays that information. In this case, the optical pickup 310 gets audio/video information decoded by the SD decoder 3150 and output to the TV 321 and the loudspeakers 322.

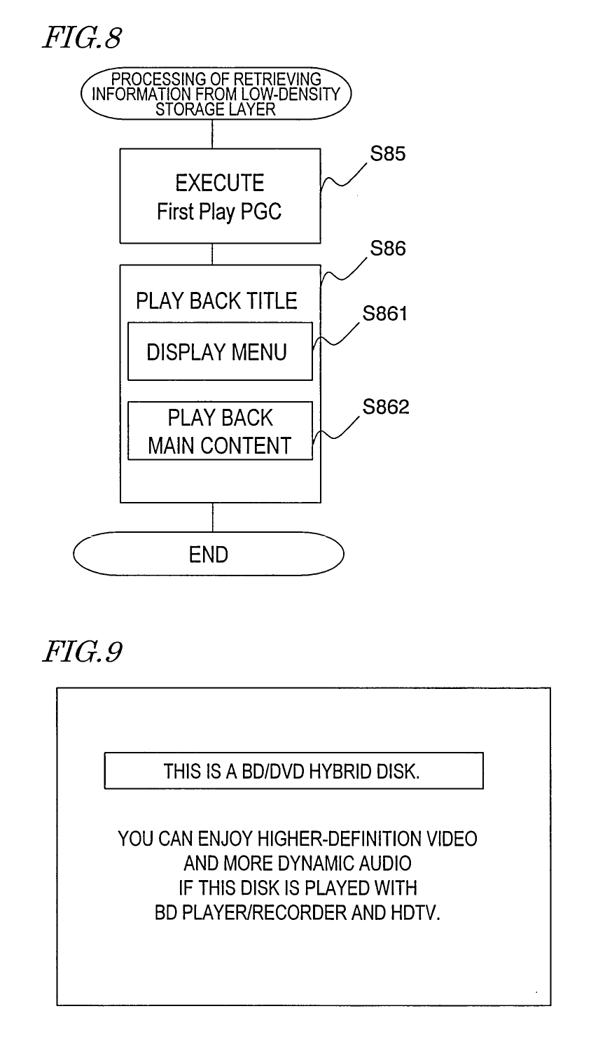

It should be noted that the video and other types of information presented to the user change depending on whether the information is read out from the low-density storage layer 104 of the optical disk 100 or the DVD's storage layer thereof. Hereinafter, the playback process to be performed on the low-density storage layer 104 will be described with reference to FIGS. 8 and 9.

In the following description, the processing shown in FIGS. 8 and 9 is supposed to be carried out by the player 300. However, the statement of this processing is also applicable to even a situation where a conventional read-only DVD player is performing playback processing on the low-density storage layer 104 as a normal DVD's storage layer. The effects caused by the method shown in FIGS. 8 and 9 are achieved most significantly when the playback operation is carried out using such a DVD player.

FIG. 8 shows the procedure of information retrieval processing on the low-density storage layer 104. To start this processing, first, the physical control information stored in the lead-in 211 of the low-density storage layer 104 is read out and predetermined pre-processing is performed.

First, in Step S85, the CPU 301 instructs the optical pickup 310 to read the navigation information 2122 from the data area 212 and execute First Play PGC, which is a type of processing that is always carried out first when data is read from the data area 212 of the low-density storage layer 104.

The low-density storage layer 104 of the optical disk 100 is designed such that an image including the HD presence information 2125 is presented in the First Play PGC. That is why when starting to read information from the low-density storage layer 104, the player 300 presents the user an image indicating the presence of the high-density storage layer 102 (more specifically, an image indicating the presence of HD audio/video information) as a part of the video.

FIG. 9 shows an exemplary on-screen message indicating the presence of the high-density storage layer 102. By reading this message, the user knows that HD video can be viewed if a player that can retrieve information from the high-density storage layer and an HDTV are used in combination. If he or she uses the player 300 and an HDTV, he or she can get the initializing screen shown in FIG. 6 displayed and can change the types of processing such that information can be retrieved from the high-density storage layer 102. On the other hand, if the user uses a read-only DVD player, he or she can sense that an HD title is also included in the optical disk 100 and will be able to enjoy the HD title when he or she purchases a BD player and an HDTV sometime in the future.

It should be noted that the on-screen message including the HD presence information 2125 does not always have to be presented during the sequence of First Play PGC itself. Alternatively, when the processing branches in accordance with a command that must be executed when First Play PGC ends, that on-screen message may be presented during a sequence executed after the branch. Optionally, the light beam may be focused on the low-density storage layer 104 first unlike the example shown in FIG. 7 and that piece of information may be presented during the processing that is carried out substantially earliest.

After that, the process advances to Step S86, in which an SD title starts to be played back. More specifically, a menu is displayed in Step S861 and the main content is played back in Step S862. After that, the process ends.

The player 300 of this preferred embodiment operates as described above. In the first half of the processing through the processing steps S74, S76 and S77 shown in FIG. 7, there is no need to detect both the high-density storage layer 102 and the low-density storage layer 104 by focusing the light beam on both of these layers. That is why compared to the situation where both of these layers need to be detected by actually focusing the light beam on both of them, the processing can be done much more quickly.

Furthermore, in the processing step S79 described above, if the optical disk 100 inserted includes the high-density storage layer 102 and the low-density storage layer 104, it is determined by the output defining information whether information should be retrieved from the high-density storage layer 102 or the low-density storage layer 104. And in the processing steps that follow the processing step S79, information is retrieved in accordance with the decision. As to the storage layer to retrieve information from, the output defining information determines it with not only the user's playback environment but also his or her preference taken into consideration. That is why the player 300 can quickly start retrieving the information that can be viewed and listened to by the user and that has been requested by him or her.

Even if the player 300 has the function of down-converting HD audio/video into SD audio/video, the function need not be used when the player 300 is loaded with the optical disk 100. This is because the player 300 has already recognized the presence of the low-density storage layer 104 in Step S77 and can control its operation so as to read and present the SD audio/video from the low-density storage layer 104. For that reason, only when loaded with a BD, the player 300 may use its down-converting function.

In the foregoing description of preferred embodiments, the same content is supposed to be stored with different qualities in the high-density storage layer 102 and the low-density storage layer 104 of the optical disk 100. That is why unless otherwise specified by the user, the player 300 is supposed to retrieve the HD title information 2023 from the high-density storage layer 102 preferentially in an environment where the information can be displayed with HD quality, but retrieve the SD title information 2123 from the low-density storage layer 104 in an environment where the information can be displayed only with the SD quality (see the processing steps S56 to S58 shown in FIG. 5 and the processing steps S78 and S79 shown in FIG. 7).

As the case may be, however, two different contents may be stored on the high-density storage layer 102 and the low-density storage layer 104, respectively. For example, a movie content of HD quality may be stored on the high-density storage layer 102 and a bonus content of that movie such as the filmmaking process audio and video of that movie of SD quality may be stored on the low-density storage layer 104. Or a movie content of HD quality may be stored on the high-density storage layer 102 and a bonus content of SD quality that has nothing to do with that movie may be stored on the low-density storage layer 104.

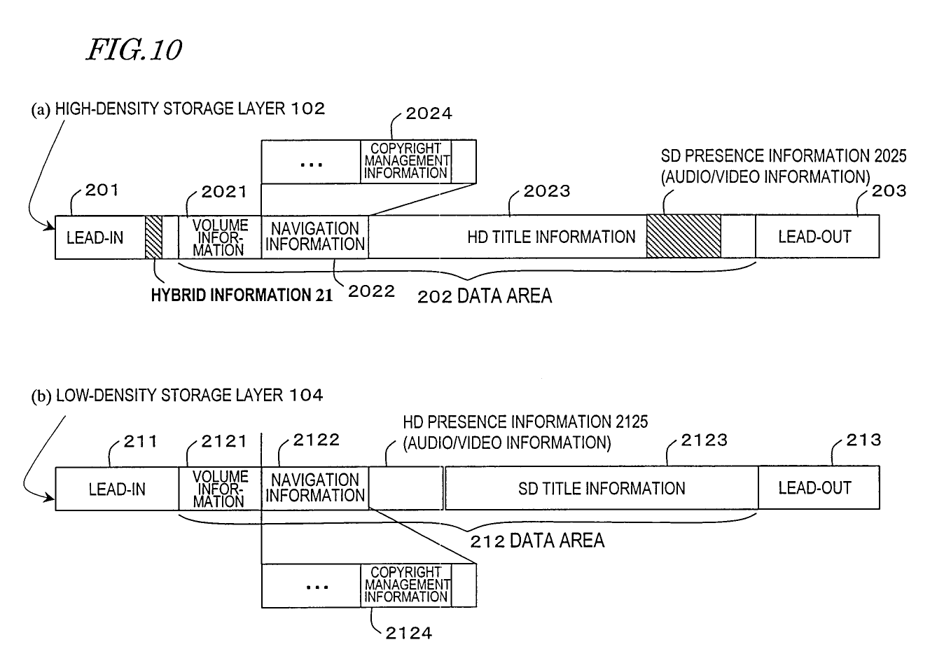

In that case, even if HD video is played back based on the HD title information 2023 stored on the high-density storage layer 102, the user is preferably notified that there is the low-density storage layer 104 and that a different content is stored there. Thus, a new data structure will be proposed with reference to FIG. 10.

FIGS. 10(a) and 10(b) show other exemplary data structures for the high-density storage layer 102 and low-density storage layer 104. The data structure of the high-density storage layer 102 shown in FIG. 10(a) is different from that shown in FIG. 2(a) in that SD presence information 2025 is further stored in the data area 202 of the high-density storage layer 102.

The SD presence information 2025 is provided as audio/video information indicating that there is the low-density storage layer 104 and/or that an SD quality content is stored separately from an HD quality content. This SD presence information 2025 is presented at an arbitrary time before the HD title information 2023 starts to be displayed or after the HD title information 2023 has been displayed. Its timing (i.e., presentation order) is defined by the navigation information 2022, for example.

On the other hand, the data structure of the low-density storage layer 104 shown in FIG. 10(b) is the same as that shown in FIG. 2(b). However, the audio/video information stored as the HD presence information 2125 may have different contents from the message displayed in FIG. 9. For example, audio/video information, indicating that the content stored on this storage layer is just a bonus content and that the main content could only be played back with a BD player, may be stored as the HD presence information 2125. When starting to retrieve information from the high-density storage layer 102, the player 300 reads the hybrid information 21 to confirm whether or not there is the low-density storage layer 104. If the information indicates the presence of the low-density storage layer 104, then the SD presence information 2025 is read out from the high-density storage layer 102 and a video signal and/or an audio signal, indicating the presence of the low-density storage layer 104 or the presence of SD audio/video, is output to the TV 321.

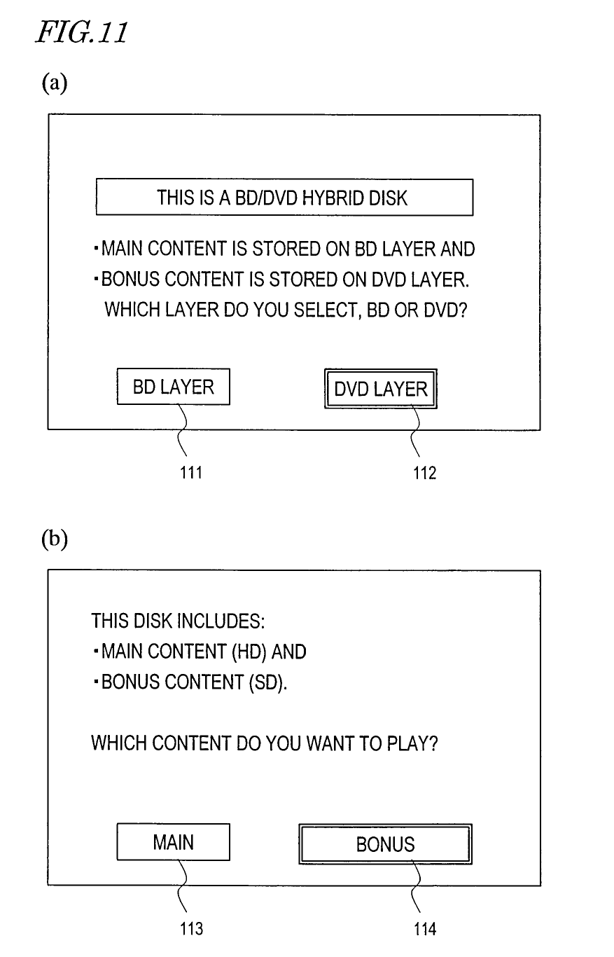

FIG. 11(a) shows an exemplary on-screen message indicating the presence of the low-density storage layer 104. The DVD layer shown in FIG. 11(a) corresponds to the low-density storage layer 104. In this example, the user is prompted to decide from which layer the information should be retrieved, the BD layer or the DVD layer. In selecting the BD layer, he or she needs to highlight the box 111 using a remote controller (not shown) and then enter his or her selection. On the other hand, in selecting the DVD layer, he or she needs to highlight the box 112 using the remote controller (not shown) and then enter his or her selection. In FIG. 11(a), the box 112 is now highlighted. Then, the player 300 retrieves information from the selected storage layer. If necessary, the CPU 301 instructs the optical pickup 310 to change the wavelengths of the light beam or tells the layer specifying section 312 which storage layer to read information from. In accordance with this instruction, the layer specifying section 312 changes the storage layers on which the light beam should be focused. Also, as in the example described above, the layer specifying section 312 may switch the transmission lines of the read signal supplied from the signal switching section 313 into that leading to the SD decoder 3150.

It should be noted that the message shown in FIG. 11(a) is just an example and a different message could tell the user that this is a hybrid disk. For example, FIG. 11(b) shows an exemplary on-screen message notifying the user that there is a standard quality content. In the example shown in FIG. 11(b), the information about the main content of a movie is supposed to be stored on the high-density storage layer 102, while a bonus content thereof is supposed to be stored on the low-density storage layer 104.

According to this notification method, the user knows the presence of the bonus content and indirectly senses the presence of the low-density storage layer 104. As the user does not have to pay attention to the fact that this is a hybrid disk, this method is easily understandable for a user of any age. By highlighting one of the boxes 113 and 114, showing the types of contents to view and listen to, using a remote controller (not shown) and entering his or her selection, he or she can select either the BD layer or the DVD layer indirectly.

The exemplary messages shown in FIGS. 11(a) and 11(b) are presented by the player 300 based on the SD presence information 2025. To compose these messages, the SD presence information 2025 includes graphic data defining the figures of the boxes to be highlighted. In many cases, a figure to be highlighted is superimposed on a background image, which is compressed image data. These data are expanded and then presented by the HD decoder 3140.

In the description of this preferred embodiment, the graphic data associated with the box 112 or 114 is linked to a command instructing that layers be switched into the low-density storage layer and information be retrieved from that layer. By executing this command, the CPU 30 performs the processing described above. This command may be stored as a part of the SD presence information. Alternatively, the command may also be included in the navigation information 2022, for example.

Also, if the player 300 can retrieve information from the high-density storage layer 102, another HD presence information (not shown) may be further stored on the low-density storage layer 104 in addition to the HD presence information 2125 and the player 300 may display the messages shown in FIGS. 11(a) and 11(b) based on that additional HD presence information. As a result, the user can view and listen to any content he or she likes by switching the BD and DVD layers one into the other. In that case, however, to prevent a conventional player that can retrieve information from only a DVD layer (i.e., low-density storage layer) from malfunctioning, the additional HD presence information should be stored in an optical disk area that the conventional player never accesses, for example.

In the preferred embodiments described above, the performance information of the TV set 320 is supposed to be acquired automatically through the HDMI interface and the result is supposed to be stored in the video output format memory 317. Alternatively, the performance information may always be set by the user by default on the initializing screen. In that case, the present invention would be applicable to even a player with no bidirectional interface or to a TV 320 without any bidirectional interface.

Also, in the preferred embodiments described above, the hybrid information 21 is supposed to be stored in the lead-in of the high-density storage layer 102. However, this is just an example. Alternatively, multiple pieces of hybrid information 21 may be stored on the header information portion of a sector, which is the minimum storage unit of the optical disk.

Furthermore, in the preferred embodiments described above, one high-density storage layer 102 and one low-density storage layer 104 are supposed to be included in the optical disk 100. However, the present invention is in no way limited to those specific preferred embodiments. Optionally, multiple high-density storage layers 102 and/or multiple low-density storage layers 104 may be present on the optical disk 100.

Furthermore, in the preferred embodiments described above, a disklike optical disk is supposed to be used. However, this is also only an example. Alternatively, a card from/on which data can be read and written optically may also be used instead.

### INDUSTRIAL APPLICABILITY

An optical storage medium according to the present invention includes two storage layers with mutually different storage densities. On one of these two storage layers, management information indicating the presence of the other storage layer is stored. And if the player notifies the user of the presence of the other storage layer based on the management information, he or she can sense the presence of that layer easily. Consequently, by using the optical storage medium of the present invention and the player of the present invention that can retrieve information from such an optical storage medium, the user can retrieve his or her desired information much more easily and handily.

1. An optical storage medium comprising a stack of first and second storage layers with mutually different storage densities,
wherein management information indicating the presence of the second storage layer is stored on the first storage layer.

2. The optical storage medium of claim 1, wherein the first storage layer has a lead-in area, and
wherein the management information is stored in the lead-in area of the first storage layer.

3. The optical storage medium of claim 2, wherein user data indicating the presence of the first storage layer is stored on the second storage layer.

4. The optical storage medium of claim 3, wherein the second storage layer has a lead-in area, and
wherein the user data is not stored in the lead-in area of the second storage layer but in a different area of thereof.

5. The optical storage medium of claim 3, wherein the second storage layer further has a data area, and
wherein the user data is stored in the data area of the second storage layer.

6. The optical storage medium of claim 5, wherein the user data relates to at least one of video and audio indicating the presence of the first storage layer.

7. The optical storage medium of claim 5, wherein sequence information defining a procedure of processing to be carried out first when data is read out from the second storage layer is stored in the data area of the second storage layer, and
wherein the sequence information defines the procedure of presenting video based on the video data.

8. The optical storage medium of claim 3, wherein each of the first and second storage layers has a data area, and
wherein a first piece of title information about a content of a first quality and a first piece of copyright management information for protecting the copyright of the content of the first quality are stored in the data area of the first storage layer, and
wherein a second piece of title information about a content of a second quality and a second piece of copyright management information for protecting the copyright of the content of the second quality are stored in the data area of the first storage layer.

9. The optical storage medium of claim 8, wherein the first and second pieces of copyright management information define mutually different copyright protection conditions.

10. A player for retrieving information from an optical storage medium, the optical storage medium comprising a stack of first and second storage layers with mutually different storage densities, management information indicating the presence of the second storage layer being stored on the first storage layer, the player comprising:
a reading section for reading the management information when the player is loaded with the optical storage medium; and
a control section for outputting information indicating the presence of the second storage layer based on the management information.

11. The player of claim 10, wherein the first storage layer has a lead-in area in which the management information is stored and a data area in which user data about at least one of video and audio indicating the presence of the second storage layer is stored, and
wherein the reading section further reads the user data, and
wherein the control section outputs at least one of video and audio based on the user data, thereby making a notification of the presence of the second storage layer.

12. The player of claim 10, wherein the second storage layer has a data area in which user data about at least one of video and audio indicating the presence of the first storage layer is stored, and
wherein the reading section further reads the user data from the second storage layer, and
wherein the control section outputs at least one of video and audio based on the user data of the second storage layer, thereby making a notification of the presence of the first storage layer.

13. A player for retrieving information from an optical storage medium, the optical storage medium comprising a stack of first and second storage layers with mutually different storage densities, video information of a first definition being stored on the first storage layer, video information of a second definition being stored on the second storage layer, the player comprising:
a memory that stores in advance output information specifying definition of video to output;
a control section for selecting, in accordance with the output information, either the first storage layer or the second storage layer to read video information from when the player is loaded with the optical storage medium; and
a reading section for reading the video information from the first or second storage layer selected.

14. The player of claim 13, further comprising an interface section that receives information, specifying a signal format acceptable for an output device, as the output information from a user.

15. The player of claim 13, further comprising an interface section that receives information, specifying a signal format acceptable for an output device, as the output information from the output device.
